(19) United States
(12) Patent Application Publication
(10) Pub. No.: US 2010/0107256 A1
(43) Pub. Date: Apr. 29, 2010

(54) Methods for Software Virus Protection in a Digital Display Device

(75) Inventors: Jiping Zhu, San Jose, CA (US); Yusheng Zhang, San Jose, CA (US); Michael Yip, Los Altos, CA (US)

Correspondence Address: Venture Pacific Law, PC, 5201 Great America Parkway, Suite 270, Santa Clara, CA, 95054, US

(73) Assignee: AMLOGIC, INC., Santa Clara, CA (US)

(21) Appl. No.: 12/259,271

(22) Filed: Oct. 27, 2008

(51) Int. Cl. G06F 21/00

(52) U.S. Cl. 726/24

(57) ABSTRACT

This invention relates to methods for identifying potentially infected files downloaded to a digital display device (“DDD”) and for managing those potentially infected files. These methods may include the steps of: connecting the DDD to a device; downloading one or more files to the DDD; disconnecting the DDD from the device; verifying and repairing the boot sector of the DDD; removing the one or more downloaded files that are not supported for playback on the DDD; and scanning the one or more downloaded files that are supported for playback on the DDD.

### FIELD OF INVENTION

This invention relates to methods for software virus protection for a digital display device, such as a digital picture frame. In particular, this invention relates to methods for identifying potentially infected files stored on a digital display device and to methods for managing those potentially infected files.

### BACKGROUND

A digital display device (“DDD”), such as a digital picture frame (“DPF”), provides for the display of a collection of photos, images, videos, or other content. The advancement in the mass production of liquid crystal displays (“LCDs”) resulted in the lowering of the cost of the LCDs, and therefore DDDs which use the LCD technology for displaying images. As DDDs become more and more popular, the particular problems associated with DDDs are becoming apparent and require customized solution.

A DDD may display one or more files or play one or more files by retrieving those files from its internal storage. The DDD also has the capability to download files from a variety of devices, such as cellular phones, digital cameras, computers, servers, multimedia cards, or other sources that can provide content to the DDD. Additionally, the DDD can upload files stored in its internal storage to external devices. Due to the ease of transferring data and the variety of devices that the DDD can transfer data with, the DDD plays an important role in preventing the propagation of software viruses.

Software viruses can include computer viruses, worms, trojans, rootkits, backdoor programs, spyware programs, botnets, keystroke logging programs, adwares, malicious software programs, and other programs designed to infiltrate or damage a computer system without the computer owner's informed consent.

The DDD is especially a target for software viruses due to its simplistic design. Generally, the DDD plays one or more files and/or displays one or more files with little other functionality. For instance, antivirus protection programs, such as firewalls, antivirus software, popup-blocker programs, and other security measures, may not be provided for or even supported by the DDD.

In particular, when a DDD downloads files from an external device, the DDD may store the files internally for playback. If a software virus is contained in one of those files, then the software virus may undesirably alter the function of the DDD or may infect other devices connected to the DDD.

The DDD may be infected by downloading files through a variety of means and from a variety of external devices. For instance, FIG. 1a illustrates a DDD being infected by a virus through a variety of external devices. A DDD 102 may be infected through the internet by downloading one or more files from a computer 114. The DDD 102 may connect to the internet by way of a broadband connection 104 or a telephone line 106. The DDD 102 may also be infected by downloading files directly from a computer 110 or from a multimedia storage card 108.

After a DDD has been infected by a software virus, the virus may propagate to other devices connected to the DDD. FIG. 1b illustrates a DDD 102 acting as a carrier for the software virus and infecting other devices through the internet, such as a computer 116. Devices that may be infected include computers, personal digital assistants, cellular phones, and other devices that may be harmed by software viruses. FIG. 1c illustrates the DDD 102 infecting other devices through direct and indirect connections to the DDD 102. An indirect connection may be where a DDD infects another device through one or more intermediary devices, such as where a media card 128, infected by the DDD 102, infects a computer 126. Furthermore, a computer 124 may be infected by the DDD 102 through a direct connection between the DDD 102 and the computer 124.

As evidenced through the examples above, a DDD can be susceptible to infection by software viruses and thus propagate those viruses to other devices connected to the DDD. Therefore, it is desirable to provide methods for managing potential software viruses stored on a DDD.

### SUMMARY OF INVENTION

An object of this invention is to provide methods for protecting a DDD against software viruses.

An object of this invention is to provide methods for preventing the propagation of software viruses via a DDD.

Briefly, this invention relates to methods for identifying potentially infected files downloaded to a DDD and for managing those potentially infected files. These methods may include the steps of: connecting the DDD to a device; downloading one or more files to the DDD; disconnecting the DDD from the device; verifying and repairing the boot sector of the DDD; removing the one or more downloaded files that are not supported for playback on the DDD; and scanning the one or more downloaded files that are supported for playback on the DDD.

An advantage of this invention may be to protect a DDD against software viruses, and, in particular, to prevent software viruses from altering the functions of a DDD.

Another advantage of this invention may be to prevent the propagation of software viruses via a DDD.

### DESCRIPTION OF THE DRAWINGS

The foregoing and other objects, aspects, and advantages of the invention will be better understood from the following detailed description of the preferred embodiment of the invention when taken in conjunction with the accompanying drawings in which:

FIG. 1a illustrates a DDD downloading a virus from a variety of devices.

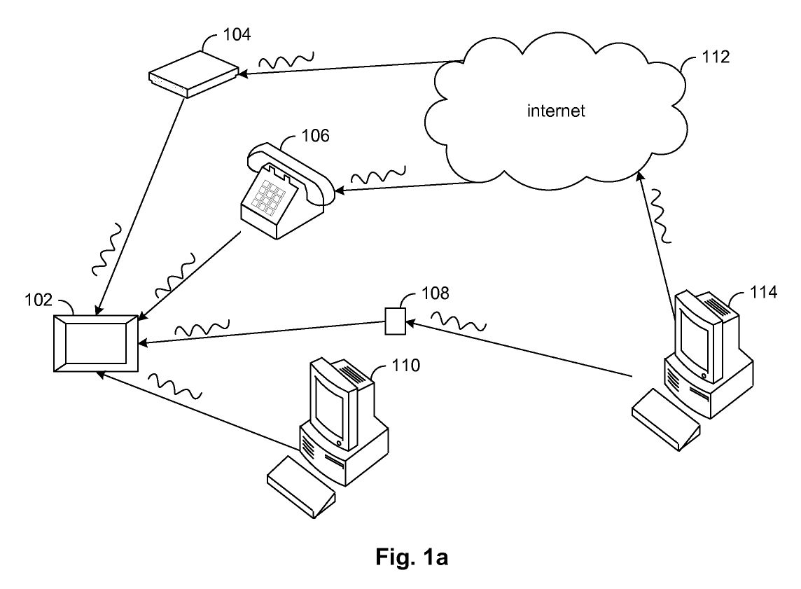

FIG. 1b illustrates a DDD uploading a virus to a computer through the internet.

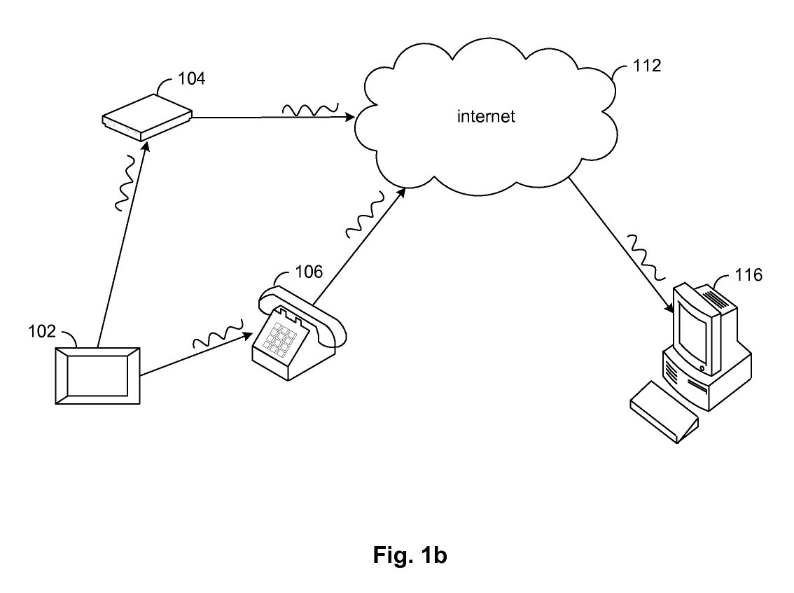

FIG. 1c illustrates a DDD uploading a virus to a variety of devices.

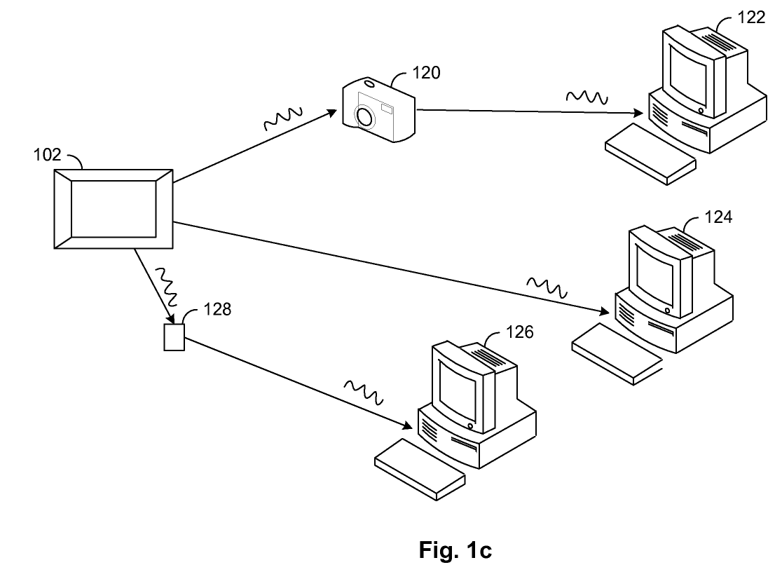

FIG. 2a is a process flow for downloading one or more files from a device and managing those downloaded files by removing zero or more downloaded files from the DDD that are not supported for playback on the DDD.

FIG. 2b is a process flow for downloading one or more files from a device and managing those downloaded files by scanning the downloaded files for software viruses.

FIG. 2c is a process flow for downloading one or more files from a device and managing those downloaded files by removing files from the DDD that are not supported for playback on the DDD and scanning files that are supported for playback for software viruses.

FIG. 3 illustrates a process flow for uploading one or more files to a device.

### DETAILED DESCRIPTION OF THE PREFERRED EMBODIMENTS

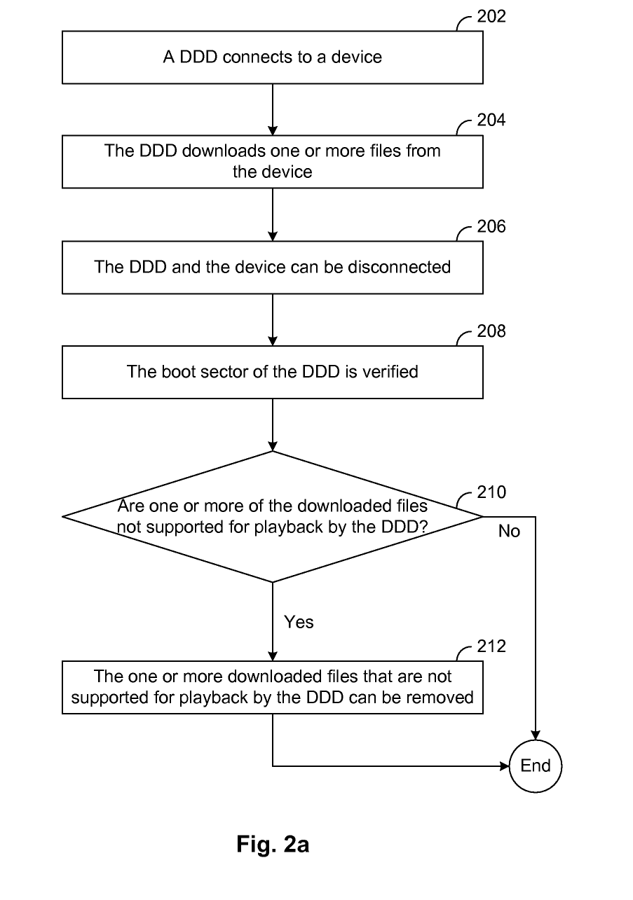

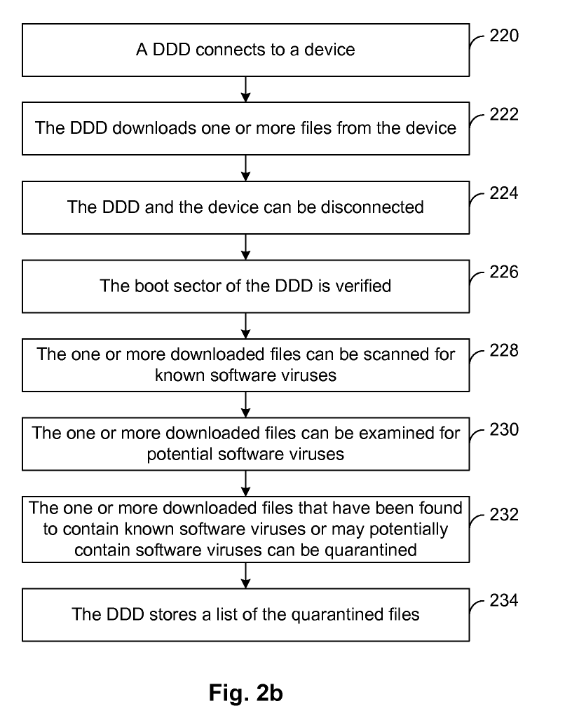

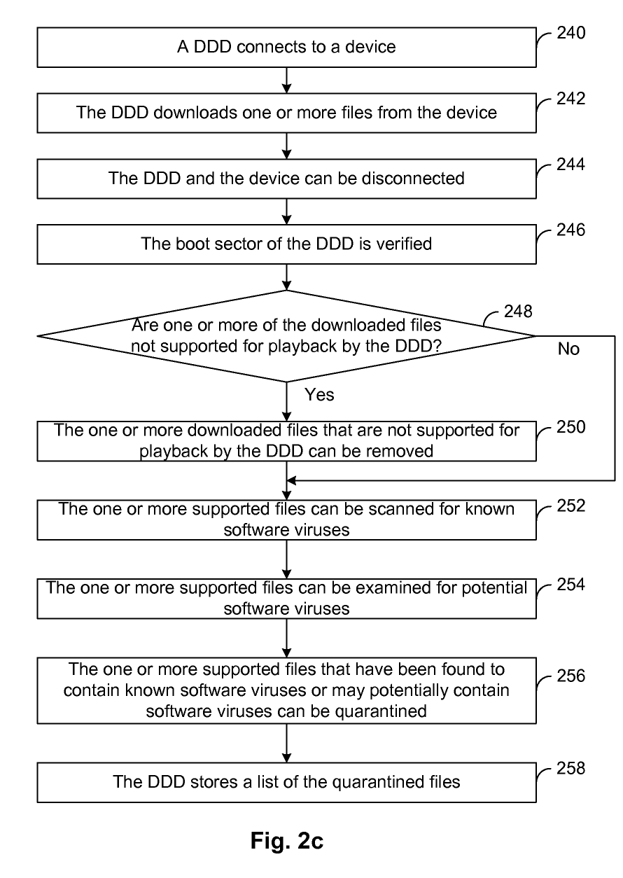

FIG. 2a illustrates a process flow of the present invention for downloading one or more files from a device and managing those downloaded files by removing zero or more downloaded files from the DDD that are not supported for playback on the DDD. A DDD first connects to a device 202. This connection can be made by connecting the DDD to the device by way of a universal serial bus (“USB”) connection, a multimedia card reader, a network connection (where that network connection can be via the internet, a LAN, a peer-to-peer network, or other networks), or other interface systems. A device may include the following: a hard drive, a computer, a server, a cell phone, a personal digital assistant, a camera, a multimedia card such as a secure digital card, a compact flash card, or other flash memory cards, and other devices.

Once a connection has been established, the DDD searches for one or more files to download from the device. This search may be initialized based on an automatic update schedule for the DDD that has been defined by a DDD user or predefined by the DDD. An example of an automatic update schedule that can be predefined by the DDD may be where files are downloaded from a server through the internet on a weekly basis. The DDD user may also have the option to set a search schedule. For instance, the DDD user can set the search for files on a daily basis instead of the DDD's predefined setting. Also, the DDD user can select specific files to add from a device, thus manually initiating files to be downloaded to the DDD.

If there are files to download, then the DDD downloads one or more files from the device 204. After downloading to the DDD is complete, the DDD and the device can be disconnected 206. If the connection with the device is prematurely disconnected before the download is complete, then the DDD can process one or more files that were downloaded before the connection was disconnected. For instance, a DDD can be prematurely disconnected from a device when a DDD user physically unplugs the connection between the DDD and the device before the DDD has finished downloading files from the device.

Once the DDD is no longer connected with the device, the boot sector of the DDD is verified 208 to check whether a software virus has infected the DDD's boot sector. If any software viruses have infected the boot sector, then the boot sector is repaired.

Usually, software viruses are stored within executable files. An executable file can be a file that contains machine instructions for a computer program. If executable files are not permitted to be stored in the DDDs internal storage, then DDDs may, to a certain extent, be protected from infection by software viruses and be protected from spreading software viruses. DDDs generally do no support executable files since these files cannot be displayed or played on DDDs. Therefore, the functionality of DDDs may not be affected by preventing executable files from being downloaded into DDDs.

By limiting the type of files that are stored in the DDD, the DDD can prevent the propagation of software viruses through the DDD by only storing files that are supported for playback on the DDD, where playback can mean displaying images or playing sound. Files that can be supported for playback on the DDD can include video files, audio files, image files, text files, adobe pdf files, and other files that can be supported by the DDD.

The DDD checks whether one or more of the downloaded files are not supported for playback by the DDD 210. The one or more downloaded files that are not supported for playback by the DDD can be removed 212.

Although this method is simple to implement with low complexity, it, however, does not take into account the variety of software viruses. For instance, many viruses may be hidden in files that are supported for playback by the DDD or may disguise itself as a file that is supported for playback. Thus, software viruses may be downloaded to the DDD, thereby infecting the DDD and possibly infecting devices connected to that DDD. In order to combat a larger assortment of software viruses, other methods of this invention may implement scanning downloaded files for software viruses.

FIG. 2b shows another process flow of the present invention for downloading one or more files from a device and managing those downloaded files by scanning the downloaded files for software viruses. First, a DDD connects to a device 220. Once a connection is established, one or more files can be downloaded from the device to the DDD 222, where those files have been selected for download to the DDD by an automatic update or by the DDD user. Next, the DDD and the device can be disconnected 224. The boot sector is verified 226 in a similar manner as stated above.

After verification, the one or more downloaded files are scanned for known viruses 228. This may be performed by comparing the one or more downloaded files with a database of software virus signature definitions. A virus signature definition can be a characteristic byte-pattern that is part of a certain software virus or family of software viruses. If the scanner finds such a pattern in a file, then the file is identified as possibly containing a software virus. The disadvantage of this detection method is that only software viruses that pre-date the last update of the database of software virus signature definitions can be detected. The files identified with potential software viruses are noted and stored for later retrieval.

Since newly developed software viruses, self-altering viruses, and other software viruses may not be identified by comparing the infected file with a database of software virus signature definitions, another level of detection may be added. Files may be identified to potentially contain software viruses 230 by comparing common behaviors of the files and known viruses or by using other methods for software virus detection.

The files identified as containing known viruses or identified as potentially containing viruses may be quarantined from the DDD 232. This quarantining step may entail denying access of the quarantined files to the resources of the DDD and from allowing the DDD user to access the quarantined file. A list of the quarantined files may also be stored for later retrieval and use 234. The quarantine list can be stored internally on the DDD, as well as externally on a server, a computer, or other external devices.

FIG. 2c illustrates yet another process flow of the present invention for downloading one or more files from a device and managing those downloaded files by removing files from the DDD that are not supported for playback on the DDD and scanning files that are supported for playback for software viruses. First, a DDD connects to a device 240. Once a connection has been established, one or more files are downloaded from the device to the DDD 242, where those files have been selected for download to the DDD by an automatic update or by the DDD user. Next, the DDD and the device can be disconnected 244 while it still can be connected to the internet or a computer. The boot sector is verified 246 in a similar manner as stated above.

The DDD checks whether one or more of the downloaded files are not supported for playback by the DDD 248. The one or more downloaded files that are not supported for playback by the DDD can be removed 250.

The one or more downloaded files that are supported for playback can be scanned for known viruses 252. This may be performed by comparing the one or more files with a database of software virus signature definitions.

The one or more downloaded files that are supported for playback can be examined for software viruses 254 by comparing common behaviors of the files and known viruses or by using other methods for software virus detection.

The files identified as containing known software viruses or identified as potentially containing software viruses may be quarantined by the DDD 256. This quarantining step may entail denying access by the quarantined files to the resources of the DDD and from allowing the DDD user to access the quarantined files. A list of the quarantined files may also be stored for later retrieval and use 258.

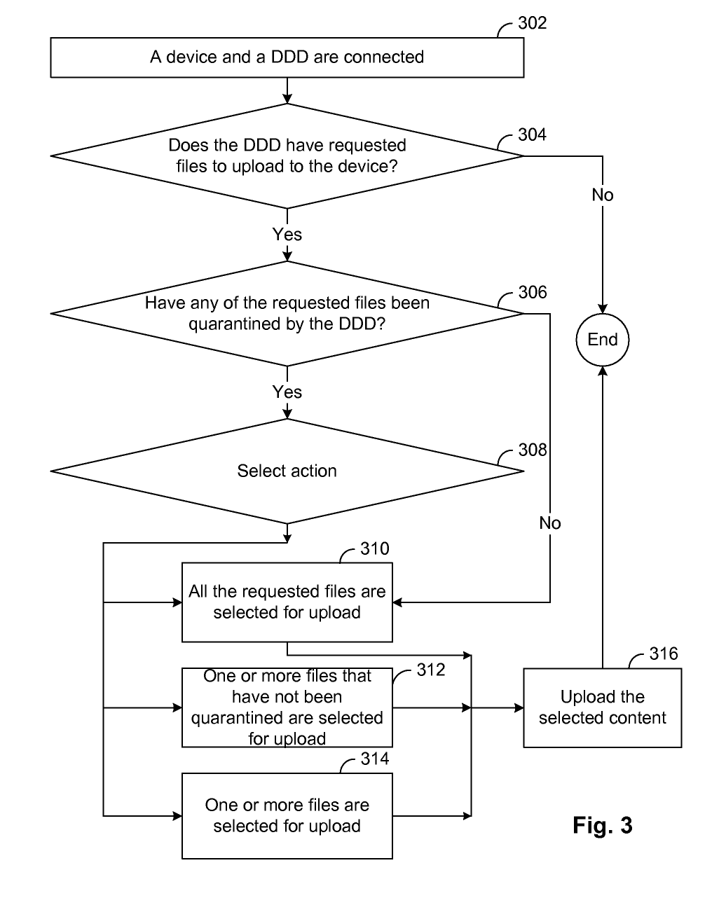

FIG. 3 is a process flow for uploading one or more files to a device, where the device requests one or more files from a DDD. The DDD and the device connect to each other 302. The internal storage of the DDD can be searched for the requested files 304. If the DDD has one or more of the requested files stored in its internal storage, then the DDD checks whether one or more of the stored files have been quarantined 306. If one or more of the stored files have been quarantined, then several actions 308 may follow, including: (1) selecting all the stored files for upload 310; (2) selecting the stored files that have not been quarantined for upload 312; and (3) selecting one or more of the stored files for upload 314, regardless of whether one or more of the stored files have been quarantined. The selection may be chosen by the user or automatically selected by the DDD. Finally, the one or more selected files are uploaded to the device 316.

While the present invention has been described with reference to certain preferred embodiments or methods, it is to be understood that the present invention is not limited to such specific embodiments or methods. Rather, it is the inventor's contention that the invention be understood and construed in its broadest meaning as reflected by the following claims. Thus, these claims are to be understood as incorporating not only the preferred methods described herein but all those other and further alterations and modifications as would be apparent to those of ordinary skilled in the art.

We claim:

1. A method for managing software viruses in a digital display device (“DDD”), said DDD having a boot sector, comprising the steps of:
connecting the DDD to a device;
downloading one or more files to the DDD;
disconnecting the DDD from the device;
verifying and repairing the boot sector of the DDD;
removing the one or more downloaded files that are not supported for playback on the DDD; and
scanning the one or more downloaded files that are supported for playback on the DDD for software viruses.

2. The method of claim 1, wherein in the scanning step, the one or more files supported for playback are compared with a database of known software virus signatures.

3. The method of claim 1, wherein in the scanning step, the one or more files supported for playback are compared with known software viruses based on common behaviors between the one or more files supported for playback and the known software viruses.

4. The method of claim 1, further including a step after the scanning step of, quarantining zero or more of the scanned files that contain potential software viruses.

5. The method of claim 1, further comprising the step of selecting one or more downloaded files for uploading to an external device based on the results of the scanning step.

6. The method of claim 2, wherein in the scanning step, the one or more files supported for playback are compared with known software viruses based on common behaviors between the one or more files supported for playback and the known software viruses.

7. The method of claim 2, further including a step after the scanning step of, quarantining zero or more of the scanned files that contain potential software viruses.

8. The method of claim 2, further comprising the step of selecting one or more downloaded files for uploading to an external device based on the results of the scanning step.

9. A method for managing software viruses in a DDD, said DDD having a boot sector, comprising the steps of:
connecting the DDD to a device;
downloading one or more files to the DDD;
disconnecting the DDD from the device;
verifying and repairing the boot sector of the DDD;
removing the one or more downloaded files that are not supported for playback on the DDD;
scanning the one or more downloaded files that are supported for playback on the DDD for software viruses; and
quarantining zero or more of the scanned files that contain potential software viruses.

10. The method of claim 9, wherein in the scanning step, the one or more files supported for playback are compared with a database of known software virus signatures.

11. The method of claim 9, wherein in the scanning step, the one or more files supported for playback are compared with known software viruses based on common behaviors between the one or more files supported for playback and the known software viruses.

12. The method of claim 9, further comprising the step of, selecting one or more downloaded files for uploading to an external device based on the results of the scanning step.

13. The method of claim 11, further comprising the step of selecting one or more downloaded files for uploading to an external device based upon the results of the scanning step.

14. A method for managing software viruses in a DDD, said DDD having a boot sector, comprising the steps of:
connecting the DDD to a device;
downloading one or more files to the DDD;
disconnecting the DDD from the device;
verifying and repairing the boot sector of the DDD;
removing the one or more downloaded files that are not supported for playback on the DDD;
scanning the one or more downloaded files that are supported for playback on the DDD for software viruses;
quarantining zero or more of the scanned files that contain potential software viruses; and
selecting one or more downloaded files for uploading to an external device based on the results of the scanning step.

15. The method of claim 14, wherein in the scanning step, the one or more files supported for playback are compared with a database of known software virus signatures.

16. The method of claim 14, wherein in the scanning step, the one or more files supported for playback are compared with known software viruses based on common behaviors between the one or more files supported for playback and the known software viruses.

17. The method of claim 15, wherein in the scanning step, the one or more files supported for playback are compared with known software viruses based on common behaviors between the one or more files supported for playback and the known software viruses.
